(19) United States
(12) Patent Application Publication
(10) Pub. No.: US 2026/0012785 A1
(43) Pub. Date: Jan. 8, 2026

(54) ROADSIDE UNIT

(71) Applicant: TOYOTA JIDOSHA KABUSHIKI KAISHA, Toyota-shi (JP)

(72) Inventor: Hayato MIZUMA, Tokyo (JP)

(73) Assignee: TOYOTA JIDOSHA KABUSHIKI KAISHA, Toyota-shi (JP)

(21) Appl. No.: 19/089,717

(22) Filed: Mar. 25, 2025

(30) Foreign Application Priority Data
Jul. 4, 2024 (JP) 2024-108409

(51) Int. Cl. H04W 12/03; H04W 4/44

(52) U.S. Cl. CPC H04W 12/03; H04W 4/44

(57) ABSTRACT

The roadside unit includes a sensor that detects the behavior of the mobile body, and a wireless communication unit that receives the identification information and the behavior history from the mobile body, and the wireless communication unit further receives the personal information of the user of the mobile body from the mobile body when a condition including that the received behavior history and the detection result of the sensor have a predetermined correlation is satisfied.

### CROSS-REFERENCE TO RELATED APPLICATION

This application claims priority to Japanese Patent Application No. 2024-108409 filed on Jul. 4, 2024. The disclosure of the above-identified application, including the specification, drawings, and claims, is incorporated by reference herein in its entirety.

### BACKGROUND

### 1. Technical Field

The present disclosure relates to a roadside unit.

### 2. Description of Related Art

As of recent, roadside units that are capable of communicating with vehicles have been developed. For example, Japanese Unexamined Patent Application Publication No. 2022-164499 (JP 2022-164499 A) discloses technology regarding a roadside unit that includes a communication unit and a control unit, and that performs wireless communication with vehicles traveling in thoroughfare lanes and merging lanes of a road, in which the roadside unit receives in-vehicle device identification information of in-vehicle devices that are installed in the vehicles, and external appearance information regarding external appearance of the vehicles, and matches sensing information of the roadside unit with external appearance information that is received by communication.

### SUMMARY

The in-vehicle device identification information, which is identification information of the in-vehicle device, is a unique value, and accordingly does not overlap with in-vehicle device identification information of another vehicle. On the other hand, when the in-vehicle device system is restarted by turning the ignition off and then on again, the in-vehicle device identification information is changed to a number that is different from the original number. Accordingly, drivers cannot be identified using the in-vehicle device identification information. Also, in technology such as ITS (short for “intelligent transportation system”)—Connect or the like that is used for wireless communication with vehicles, the communication is performed by broadcasting, and accordingly, including information that would enable an individual to be directly identified in a message in wireless communication is impossible in principle. Thus, transmitting personal information of a mobile body user (e.g., user ID, username, etc., of the mobile body user in an external service) as it is in a message in wireless communication, in order to collaborate with external services that are associated with the driver information, cannot be performed.

Accordingly, conventional roadside units are not capable of identifying users (drivers) of mobile bodies. Also, collaboration between information that is acquired by wireless communication with a vehicle, and external services that are associated with personal information of a user, by using the in-vehicle device identification information, is difficult.

An object of the present disclosure that has been made in light of the foregoing circumstances is to provide a roadside unit that is capable of collaborating with external services that are associated with personal information of mobile body users.

The gist of the present disclosure for solving the above problem is as follows.

(1) A roadside unit, including a sensor that detects behavior of a mobile body, and a wireless communication unit that receives identification information and behavior history from the mobile body, in which the wireless communication unit further receives personal information of a user of the mobile body from the mobile body when a condition, including that the behavior history that is received and detection results of the sensor are in a predetermined correlation, is satisfied.

(2) The roadside unit according to (1), further including a control unit that activates an application when the condition is satisfied, in which the wireless communication unit transmits a message that is specified by the application to the mobile body, with the identification information as a destination.

(3) The roadside unit according to (2) in which, when the application requests the personal information, the wireless communication unit receives, from the mobile body, the personal information of the user of the mobile body, that is encrypted.

(4) The roadside unit according to (3), in which the personal information is a user ID of the user of the mobile body that is required when using the application.

(5) The roadside unit according to any one of (1) to (4), in which the mobile body is a vehicle, and the identification information is identification information of an in-vehicle device that is installed in the mobile body.

According to the present disclosure, collaboration can be performed with external services that are associated with personal information of mobile body users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of a communication system according to an embodiment;

FIG. 2 is a flow chart illustrating an exemplary process of a roadside unit according to an embodiment; and

FIG. 3 is a flowchart illustrating an example of a processing procedure of the mobile body according to the embodiment.

### DETAILED DESCRIPTION OF EMBODIMENTS

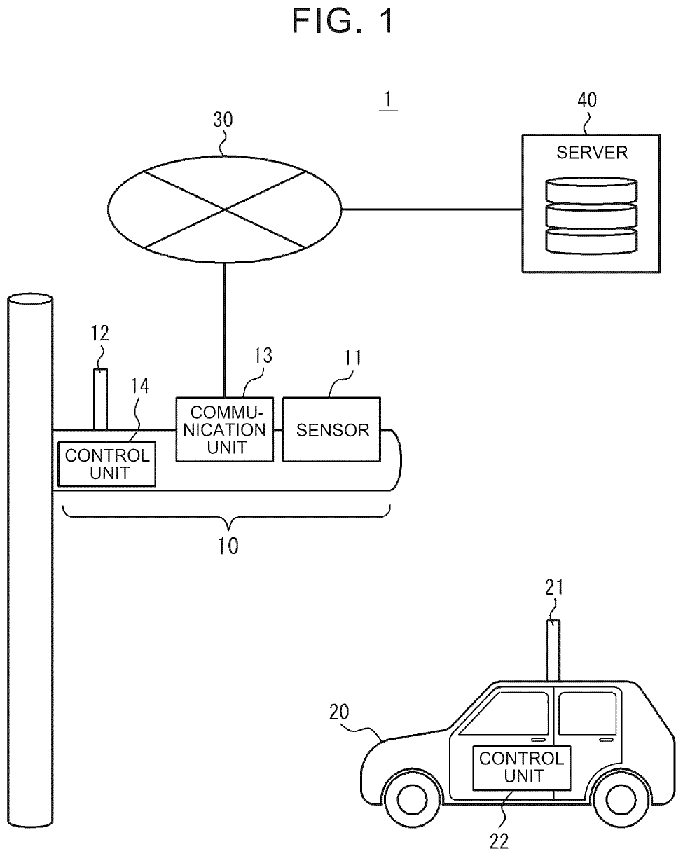

A communication system 1 according to an embodiment illustrated in FIG. 1 includes a roadside unit 10, one or more mobile bodies 20, and a server 40 connected to a communication network 30 such as the Internet. The server 40 may be a database server.

The roadside unit 10 is mounted on a pole such as a traffic signal or a utility pole. The roadside unit 10 includes a sensor 11, a wireless communication unit 12, a communication unit 13, and a control unit 14.

The sensor 11 senses the surrounding environment and detects the behavior of the mobile body 20. The sensor 11 is a visible-light camera, an infrared-ray camera, a LiDAR, or the like, and the type of the sensor is not limited. Further, the sensor 11 may be constituted by a plurality of sensors.

The wireless communication unit 12 communicates with the mobile body 20 and receives the identification information and the behavior history. The identification information is, for example, identification information of an in-vehicle device installed in the mobile body 20. The behavior history is, for example, a history of position information. The wireless communication unit 12 further receives the personal information of the user of the mobile body 20 from the mobile body 20 when a condition including a predetermined correlation between the received behavior history and the detection result of the sensor 11 (for example, the behavior history substantially matches) is satisfied.

The communication unit 13 connects to the communication network 30 wirelessly or by wire, and communicates with the server 40.

The control unit 14 starts a predetermined application when a condition including that the behavior history received by the wireless communication unit 12 and the result detected by the sensor 11 have a predetermined correlation is satisfied. The wireless communication unit 12 transmits the message specified by the application to the mobile body 20 using the identification information as a destination. When the application requests the personal information, the wireless communication unit 12 receives the encrypted personal information of the user of the mobile body 20 from the mobile body 20. The personal information is, for example, a user ID of the user of the mobile body 20 that is required when the application is used.

The mobile body 20 is, for example, a vehicle such as an automobile, a truck, or a bus. The mobile body 20 includes a V2X (Vehicle to X) wireless communication unit 21 and a control unit 22 that processes communication data. The mobile body 20 may further include an HMI (Human Machine Interface unit that provides information to the driver based on the information processed by the control unit 22.

### Disposing of Roadside Units

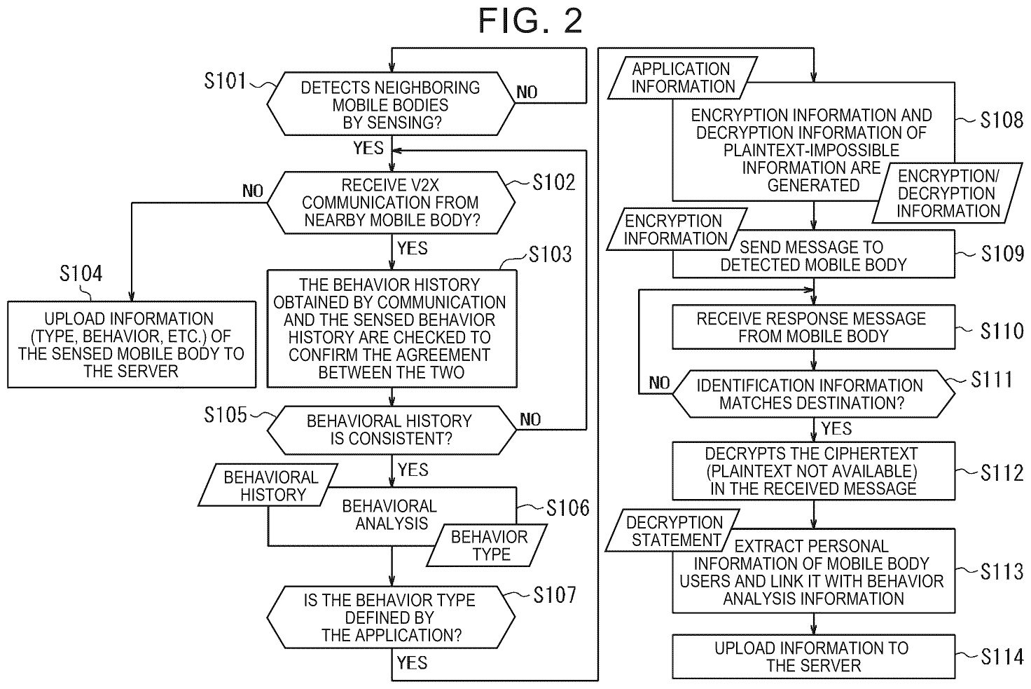

Processing of the roadside unit 10 will be described with reference to FIG. 2. The roadside unit 10 detects the nearby mobile body 20 by the sensor 11 (S101—YES), and when the wireless communication unit 12 communicates with the mobile body 20 (S102—YES), the control unit 14 compares the behavior history obtained by the communication with the sensed behavior history (S103). When the roadside unit 10 does not communicate with the mobile body 20 (S102—No), the roadside unit 10 may not do anything, or may upload information (type, behavior, etc.) of the mobile body 20 sensed by S101 to the servers 40 (S104). When the behavior histories coincide with each other (S105—YES), the control unit 14 associates identification information (for example, in-vehicle device identification information) of the mobile body 20 with each other. Hereinafter, when the mobile body 20 identified by S105 is distinguished from the other mobile bodies 20, it is referred to as a mobile body 20a.

The control unit 14 analyzes and identifies the behavior of the identified mobile body 20a (S106). When the behavior type does not satisfy a certain condition (S107—NO), the control unit 14 may terminate the process. When the behavior type satisfies a certain condition (S107—YES), the control unit 14 starts an application matching the condition. Then, when the activated application requests a response and the response message includes information (plaintext impossible information) which is inconvenient when the response message is received by the roadside unit 10 and the mobile body 20, the control unit 14 generates encryption information (for example, a public key) required for the mobile body 20a to encrypt the response information into a format that cannot be decrypted by the communication recipient other than the roadside unit 10 and the mobile body 20a, and includes the encrypted information in the transmitted message (S108). In addition, the control unit 14 generates decryption information (for example, a private key) capable of decrypting the reply information, and stores the decryption information in a storage unit (not shown) of the roadside unit 10 (S108). Note that “encryption” in S108 is encryption performed in order to further conceal part of the data included in the wireless communication message from a medium capable of receiving another V2X wireless communication received by the broadcast communication, unlike encryption of V2X wireless communication itself.

The wireless communication unit 12 transmits a message designated by the application to the mobile body 20a (S109). The wireless communication unit 12 sets the identification information of the mobile body 20a as a transmission destination, thereby eliminating the post-reception process of the mobile body 20 capable of receiving another V2X wireless communication in the vicinity and allowing the transmission message to reach only the mobile body 20a. Further, the wireless communication unit 12 causes the receiver to identify the activated application by setting a flag (hereinafter, referred to as an “application identification flag”) for identifying the type of the activated application in the transmission message. Some transmit messages request a reply from the mobile body 20a.

When the wireless communication unit 12 receives the response message from the mobile body 20 (S110), the control unit 14 confirms the identification information included in the response message, and when the identification information matches the transmission destination (S111—YES), it recognizes that the mobile body 20 is the identified mobile body 20a. When the encrypted plaintext-impossible information (ciphertext) is included in the reply message, the control unit 14 decrypts the plaintext-impossible information using the decryption information stored in S108 (S112). Then, the control unit 14 associates the behavior analyzing information with the plaintext impossible information (S113). The control unit 14 may further associate identification information of the mobile body 20a with each other. The control unit 14 confirms the application identification flag included in the reply message, and the communication unit 13 accumulates data corresponding to the application in the database of the corresponding server 40 via the communication network 30 (S114).

### Mobile Body

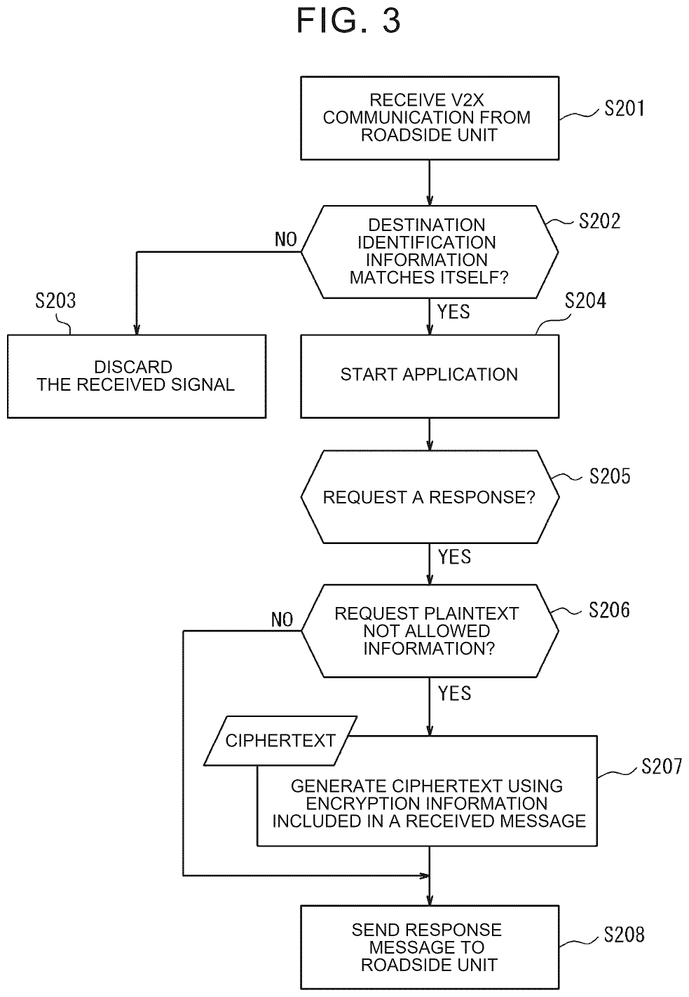

Processing of the mobile body 20 will be described with reference to FIG. 3. V2X wireless communication unit 21 receives wireless communication from the roadside unit 10 (S201). When the received information includes identification information to be a transmitting destination, the control unit 22 compares the information with its own identification information (S202). If both are identical (S202—YES), the process proceeds to the subsequent process because the communication is addressed to itself, and if both are not identical (S202—NO), the received data is discarded (S203). When the destination does not exist in the data received by S201, the mobile body 20 performs a reception process of the broadcast communication. That is, the mobile body 20 does not perform the subsequent processing, but does not discard the received information.

When the application identification flag is set in the received data, the control unit 22 reads the flag and activates an application corresponding to the flag (S204).

When the activated application requests a response to the roadside unit 10 (S205—YES), the control unit 22 determines whether or not the response content includes the evenly indivisible information (S206). When the activated application does not request a reply to the roadside unit 10 (S205—YES), the control unit 22 performs a process in accordance with an instruction from the application.

When the content of the response includes the evenly indivisible information (S206—YES), the control unit 22 encrypts the evenly indivisible information using the encryption information included in the message received from the roadside unit 10 (S207). Then, V2X wireless communication unit 21 includes the encrypted plain indivisible information (ciphertext) in the reply message, designates the communication device identification information of the roadside unit 10 as the transmitting destination, and transmits the communication device identifying information (S208). By performing S207 process, the flat inseparable information can be transmitted to the roadside unit 10 while concealing the flat inseparable information from a medium capable of receiving another V2X wireless communication that broadcasts and receives the flat inseparable information.

By performing the above processing, it is possible for the roadside unit 10 to recognize the personal information that can specify the user of the mobile body 20, instead of the in-vehicle device identification information that is normally changed every time the in-vehicle device of the mobile body 20 is activated, and to store the personal information in the database while associating the personal information with the behavior information of the mobile body 20, so that various cooperation with the mobile body behavior information to the external service that has been difficult until now becomes possible.

When the message transmitted from the roadside unit 10 contains the encryption information, the encryption method is arbitrary, and for example, a public key cryptosystem can be adopted. The issuance of the private key/public key may be calculated by edge computing by the control unit 14, or may be calculated by performing Internet communication from the roadside unit 10 via an optical fiber and using a computational resource on the Internet.

As a method of encryption, a hybrid key encryption method may be adopted. In this case, it is conceivable that the roadside unit 10 issues a public key and the mobile body 20 issues a common key. At this time, a method may be considered in which a request for issuing a common key is included in the first transmission message from the roadside unit 10 to the mobile body 20 side for the hybrid key cryptosystem, and the common key is issued by the mobile body 20 side using the request as a trigger.

The present disclosure can be applied to a point granting service (for example, a service in which a point is granted when a legal compliance action is taken) that gives a point to a mobile body user in accordance with a type of a mobile body, a behavior of a mobile body, or the like. This example will be described below.

The roadside unit 10 generates, in S108, encryption information for causing personal information (username and user ID) to be included in the reply message when the point-granting service is used, and decryption information for decrypting the encrypted personal information. Then, the roadside unit 10 transmits V2X wireless communication using the identification information of the mobile body 20a as a transmission destination by placing the encryption information and the application identification flag for starting the point-providing service on the transmission message in S109.

The mobile body 20a encrypts, at S207, the personal information required for use of the point-granting service using the encryption information included in the received message, places the encrypted personal information on the reply message at S208, and transmits V2X wireless communication to the roadside unit 10.

When the roadside unit 10 recognizes in S111 that the received V2X wireless communication information is a response message from the mobile body 20a, S112 decrypts the encrypted personal information included in the response message using the decryption information.

The roadside unit 10 stores the decrypted personal information in S114 in the data base of the server 40 of the point granting service via the Internet communication together with the behavior information or the information such as the behavior type obtained by sensing the mobile body 20a. The point assignment service assigns a point to the user of the mobile body 20a based on the stored information.

The user of the mobile body 20a can confirm the assigned point from the data stored in the data base of the server 40 during the operation of the mobile body 20a by logging in on the user client application developed by the point granting service after the operation is completed.

In conventional services such as automobile insurance, there is a technology in which a vehicle is equipped with a dedicated device, and certain vehicle data is stored in a database and used for a safe driving score or the like of vehicle insurance. However, this technique requires one dedicated device per application. On the other hand, in the present disclosure, no dedicated device is required, and development such as linking data to a plurality of applications at a time becomes possible.

As described above, the roadside unit 10 identifies the mobile body 20 that has performed a predetermined behavior from both sides of sensing and communication, further converts the personal information of the mobile body 20 into highly confidential information that can be decrypted only between the two of the mobile body 20 and the roadside unit 10, and transmits and receives the information through wireless communication performed between the roadside unit 10 and the mobile body 20. As a result, it is possible to develop a service by associating the behavior of the mobile body 20 with the personal information requested by the external application. That is, since the roadside unit 10 can associate the mobile body 20, the behavior of the mobile body 20, and the personal information of the user of the mobile body 20, it is possible to cooperate with an external service associated with the personal information of the user of the mobile body 20.

While the above-described embodiments have been described by way of representative examples, it is apparent to those skilled in the art that changes and substitutions can be made within the spirit and scope of the disclosure. For example, a plurality of steps described in the flowchart of the embodiment may be integrated into one, or one step may be divided.

What is claimed is:

1. A roadside unit, comprising:
a sensor that detects behavior of a mobile body; and
a wireless communication unit that receives identification information and behavior history from the mobile body, wherein
the wireless communication unit further receives personal information of a user of the mobile body from the mobile body when a condition, including that the behavior history that is received and detection results of the sensor are in a predetermined correlation, is satisfied.

2. The roadside unit according to claim 1, further comprising a control unit that activates an application when the condition is satisfied, wherein the wireless communication unit transmits a message that is specified by the application to the mobile body, with the identification information as a destination.

3. The roadside unit according to claim 2, wherein, when the application requests the personal information, the wireless communication unit receives, from the mobile body, the personal information of the user of the mobile body, that is encrypted.

4. The roadside unit according to claim 3, wherein the personal information is a user ID of the user of the mobile body that is required when using the application.

5. The roadside unit according to claim 1, wherein the mobile body is a vehicle, and the identification information is identification information of an in-vehicle device that is installed in the mobile body.
